(19) United States
(12) Patent Application Publication
(10) Pub. No.: US 2020/0068919 A1
(43) Pub. Date: Mar. 5, 2020

(54) METHOD FOR MAKING AN ANIMAL SNACK CONTAINING CANNABINOIDS

(71) Applicant: CP Animal Products, Las Vegas, NV (US)

(72) Inventor: Naoko Kimura, Las Vegas, NV (US)

(21) Appl. No.: 16/560,248

(22) Filed: Sep. 4, 2019

Related U.S. Application Data
(60) Provisional application No. 62/726,988, filed on Sep. 5, 2018.

(51) Int. Cl. A23K 10/30; A21D 2/16; A21D 2/34; A23K 10/20; A23K 40/00; A21D 13/80

(52) U.S. Cl. CPC A23K 10/30; A21D 2/16; A21D 13/80; A23K 10/20; A23K 40/00; A21D 2/34

(57) ABSTRACT

Techniques are provided for making an animal snack containing cannabinoids. The innovation can be separated into two categories: Animal cookie for animals without medical diagnoses and animal cookie for animals with medical diagnoses. Both categories use medical grade cannabis, however the amount of cannabinoids is different in the two categories. Category 1 has 5% containment against the weight of one of the ingredients and category 2 has 10% containment against the same. The cookie part can be printed with a uniquely embossed rolling pin for a distinguished appearance. The cookies are baked in the oven to create a crispiness that is easy to chew for older animals when consumed. Cookies can be added to animal feed or regular food by crushing cookies in small pieces.

### CROSS REFERENCE TO RELATED APPLICATIONS

This patent application claims priority from U.S. Provisional Patent Application Ser. No. 62/726,988, ANIMAL SNACK CONTAINING CANNABINOIDS, filed Sep. 5, 2018, the entirety of which is incorporated herein by this reference thereto.

### BACKGROUND OF THE INVENTION

### Technical Field

This invention relates generally to the field of production of animal snacks which contain cannabinoid-related elements. More specifically, this invention relates to a method for determining amounts of cannabinoid-related elements and applying such amounts in edible form to assist in relief of animals with ailments as well as to be appealing to such animals.

### Description of the Related Art

Presently, it has been found that an animal, such as a pet dog, having a medical condition, e.g., pancreatitis, can have medical episodes, such as lose a large percentage of weight, e.g., lose 40 lbs of a 98 lb dog, and be unable to stand on his own due to the pain of arthritis and added pancreatitis. Also, such type of medical conditions can be accompanied by age-related cognitive dysfunction and anxiety. It is known that some prescription medication, for example, for pancreatitis or liver disease as well as some of the cancer treatment medications, can make the animal feel very sick or can worsen the symptoms because of the side effects. Also, older patients, especially in palliative care stage animals, are not good candidates for some heavy dose pharmaceutical medications. Further, the price of prescription medications and medical treatments are costly as typically the veterinarian is required to perform an exam such as blood work or an x-ray to prescribe a medication. It has been found that for senior pets, the veterinarian may require additional categories of blood work which today can cost nearly $300. Many pet owners are unable to afford such exam alone. Presently, there is no effective solution to such situations other than not treating their pets at all.

Currently some cookies that contain the well-known cannabinoid, tetrahydrocannabinol (THC) for animals are sold at dispensaries or by individuals as hobby products. Those cookies do not have specific directions or explanation of effects. Homemade animal snacks made with cannabis or its extract purchased at a dispensary or on the street are not properly measured or pet owner users do not know what types of cannabinoids are contained therein how such cannabinoids might affect their pets. These can be dangerous experiments that might sometimes send their pets to the emergency room.

### SUMMARY OF THE INVENTION

Techniques are provided for making an animal snack containing cannabinoids. The innovation can be separated into two categories: Animal cookie for animals without medical diagnoses and animal cookie for animals with medical diagnoses. Both categories use medical grade cannabis, however the amount of cannabinoids is different in the two categories. Category 1 has 5% containment against the weight of one of the ingredients and category 2 has 10% containment against the same. The cookie part can be printed with a uniquely embossed rolling pin for a distinguished appearance. The cookies are baked in the oven to create a crispiness that is easy to chew for older animals when consumed. Cookies can be added to animal feed or regular food by crushing cookies in small pieces.

### BRIEF DESCRIPTION OF THE DRAWINGS

FIG. 1 is a schematic diagram showing two tables of ingredients for the base cookies, each according to an embodiment;

FIG. 2 is a schematic diagram showing equipment for creating a base element in accordance with the first step, according to an embodiment;

FIG. 3 is a schematic diagram of the scale of FIG. 2 with cannabis on its surface for being weighed, according to an embodiment;

FIG. 4 is a schematic diagram showing the cannabis being placed in an unbleached tea bag, according to an embodiment;

FIG. 5 is a schematic diagram showing how the butter is melted and the tea bag is added in; according to an embodiment;

FIG. 6 is a schematic diagram showing the melted butter mixture in cooking pot 602 and a heat resistant glass container 604, according to an embodiment;

FIG. 7 is a schematic diagram showing the basic ingredients and equipment for making the base cookie batter or dough, according to an embodiment;

FIG. 8 is a schematic diagram showing how to make the base cookie batter or dough, according to an embodiment;

FIG. 9 is a schematic diagram of the equipment for achieving the rolled cookie dough embossed with the distinctive pattern, according to an embodiment;

FIG. 10 is a schematic diagram of the process for cutting the cookies into smaller sizes and baking such cookies, according to an embodiment;

FIG. 11 is a flowchart showing an example of a method for making cannabis cookies, according to an embodiment; and

FIG. 12 is a flowchart showing an example of a method for making cannabis butter, according to an embodiment.

### DETAILED DESCRIPTION

The present innovation includes but not limited to use of cannabinoids as a natural remedy to create animal snack that assists in variety of medical and nonmedical symptoms. This product can be used for any animal including domestic animal, livestock, and wild animal. In addition to consuming the product as a snack item, the products or the cannabis butter can also be mixed with regular animal feed or food.

Various aspects of the innovative animal snack containing cannabinoids may have one or more of the following advantages:
Very easy to consume;
Looks and taste delicious;
Prevents the dangerous experimental treatment;
Assists in relieving medical symptoms;
Assists in improving quality of life for palliative care stage animals; and
Provides relief for medical symptoms with almost no side effects.

In accordance with embodiments herein, the innovation is separated into two categories, as follows (in no particular order): 1. Animal snack, cookie for animals without medical diagnoses; and 2. Animal snack, cookie for animals with medical diagnoses. Both categories use medical grade cannabis, however the amount of cannabinoids is different in the two categories. Category 1 has 5% containment against the weight of one of the ingredients and category 2 has 10% containment against the same. Separating the innovation into two categories prevents the limitation for the pet owner users without medical diagnoses for their pets not be able to have access to this effective natural remedy for their animals. In an embodiment, the cookie part is printed with a uniquely embossed rolling pin for distinguished appearance. The cookies are baked in the oven to create a sense and feel of crispiness that is easy to chew for older animals when consumed. Cookies can be added to animal feed or regular food by crushing cookies in small pieces.

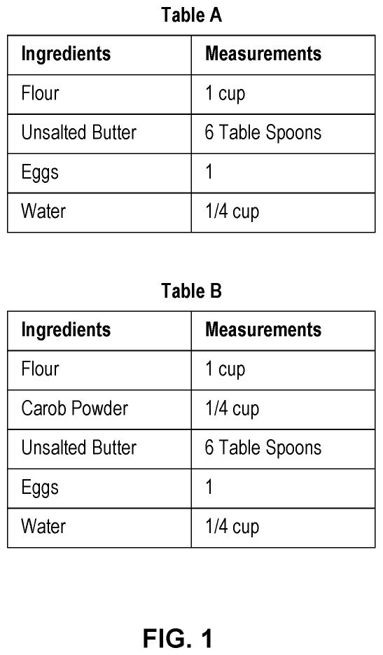

An embodiment can be understood with reference to FIG. 1, a schematic diagram showing two tables of ingredients for the base cookies. Table A indicates the ingredients and the respective measurements for what can be referred to as regular cookies. Table B indicates the ingredients and the respective measurements for chocolate flavor cookies. Each of these types of ingredients can be used as the base cookie dough for the innovation, the details of which will become apparent in the below. It should be appreciated that the chocolate flavor can be left out, depending on the desires of the user with the intention of what is suitable for the animal who will consume such resulting cookie.

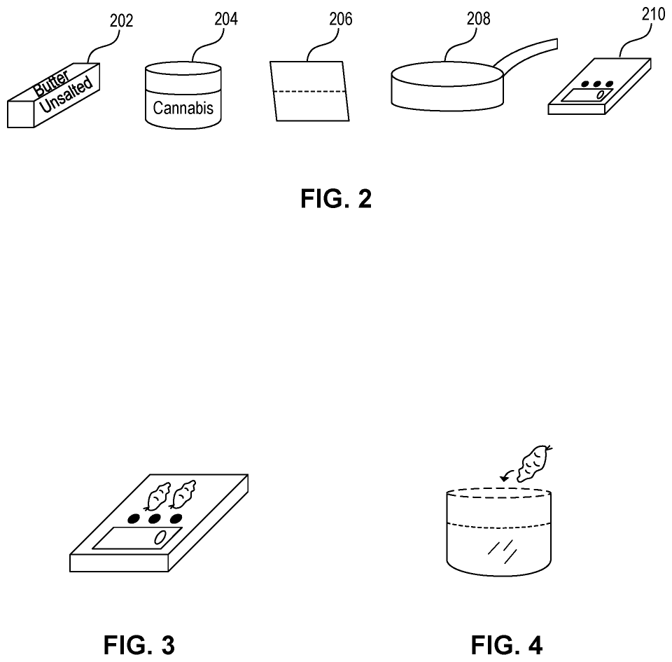

An embodiment can be understood with reference to FIG. 2, a schematic diagram showing equipment for creating a base element in accordance with the first step of the embodiment. In the embodiment, the required elements include: unsalted butter 202; cannabis 204, a tea bag or equivalent pouch to hold the cannabis and to filter out the cannabis residue from the leaves; a small cooking pot 208 on which to melt unsalted butter 202; and a scale 210 on which to weigh the cannabis. It should be appreciated that these exact elements can be substituted with similar elements that can achieve the same results. For example, in an embodiment, unsalted butter 202 can be melted in a stove top pan. As another example, the cannabis can be pre-weighed and the maker of the innovative cookies does not have to perform the weighing function. As another example, another user might not have unsalted butter available and might want to make the cookies with another butter substitute that is animal-friendly and not toxic for the animal.

An embodiment can be understood with reference to FIG. 3, a schematic diagram of the scale of FIG. 2 with cannabis on its surface for being weighed. The innovative cookies require using 10% of the cannabis against the weight of the unsalted butter.

An embodiment can be understood with reference to FIG. 4, a schematic diagram showing the cannabis being placed in an unbleached tea bag. It should be appreciated that in other embodiments, the cannabis is placed in either one or two bags. The number of bags is not limiting. Also, while it is preferred that the bag be unbleached, embodiments herein contemplate using bag that might not be unbleached.

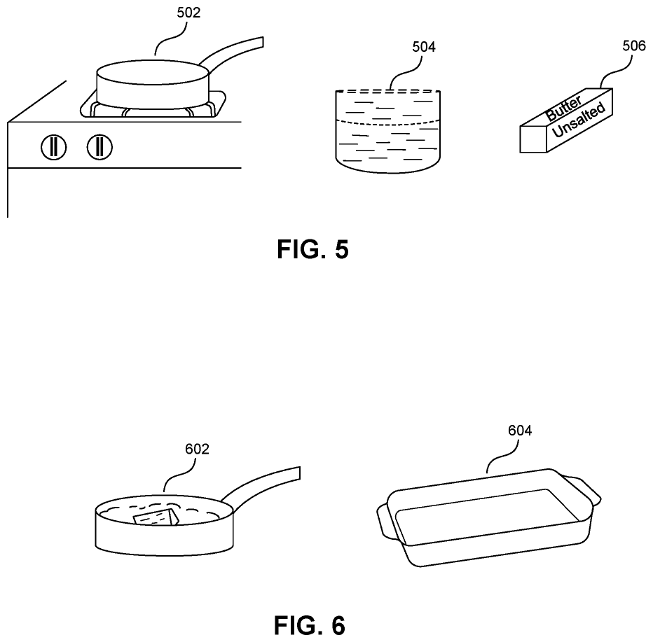

An embodiment can be understood with reference to FIG. 5, a schematic diagram showing how the butter is melted and the tea bag is added in. In the embodiment, the individual places the butter 506 in a small cooking pot 502 and melts such butter in medium heat. As butter 506 is melting or after butter 506 has melted, then tea bag 504 of FIG. 4 is added into the melted butter mixture in cooking pot 502. Subsequently, the user brings the melted mixture with the cannabis tea bag almost to a boiling temperature and then turns off the stove. After turning off the stove, set aside such cooking pot 502 with the melted mixture with the cannabis tea bag.

An embodiment can be understood with reference to FIG. 6, a schematic diagram showing the melted butter mixture in cooking pot 602 and a heat resistant glass container 604. The melted butter mixture in cooking pot 602 is transferred to heat resistant glass container 604, then cooled. In an embodiment, the tea bag is removed just before the butter mixture starts to coagulate. In an embodiment, the length of time for the pouch to be left in the butter as the butter begins to coagulate is approximately 8-10 hours. The butter mixture without the tea bag may be kept it in the refrigerator for storage and later usage.

It should be appreciated the FIGS. 1-6 can be considered as part of the process of making cannabis butter. For example, such cannabis butter can be used for the animal cookies as described in detail below or can be used for other purposes, such as but not limited to cannabis butter on toast. Thus, the use of the such cannabis butter in the making of the innovative animal cookies is further described below.

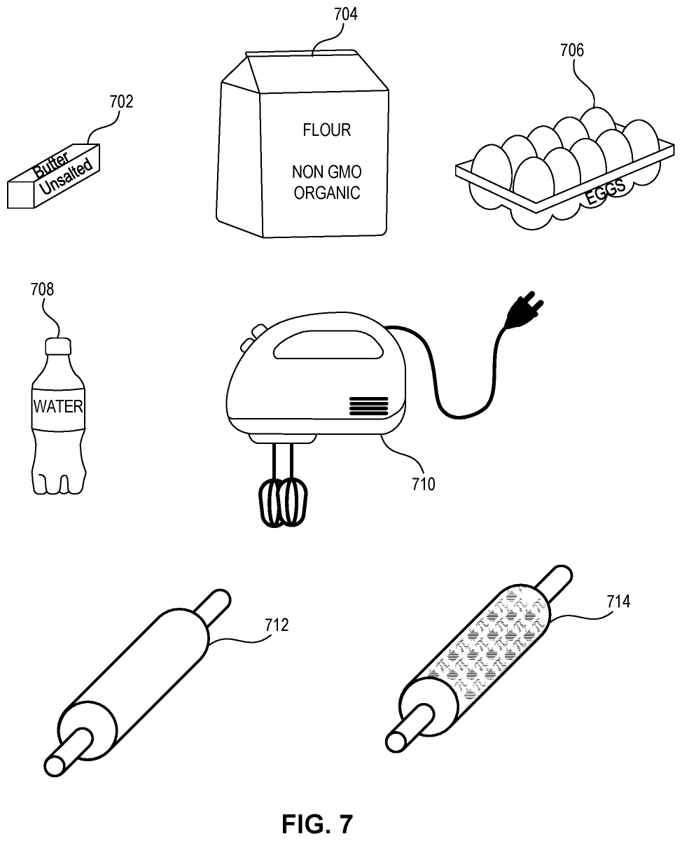

An embodiment can be understood with reference to FIG. 7, a schematic diagram showing the basic ingredients and equipment for making the base cookie batter or dough. As mentioned above, the base cookie dough uses unsalted butter 702 or its equivalent; baking flour 704 such as non-gmo and organic; eggs 706 such as eggs 706 from pastured-raised hens; water 708; a blender 710 such as an electric blender or a manual blender; a rolling pin 712 or equivalent to roll out the cookie dough; and an embossed rolling pin 714 or equivalent to imprint a unique and distinguishing design or mark on the innovative animal cookies with cannabis. It should be appreciated that for purposes herein, non-gmo means that the element (e.g., flour) is made without ingredients that were derived from genetically engineered organisms.

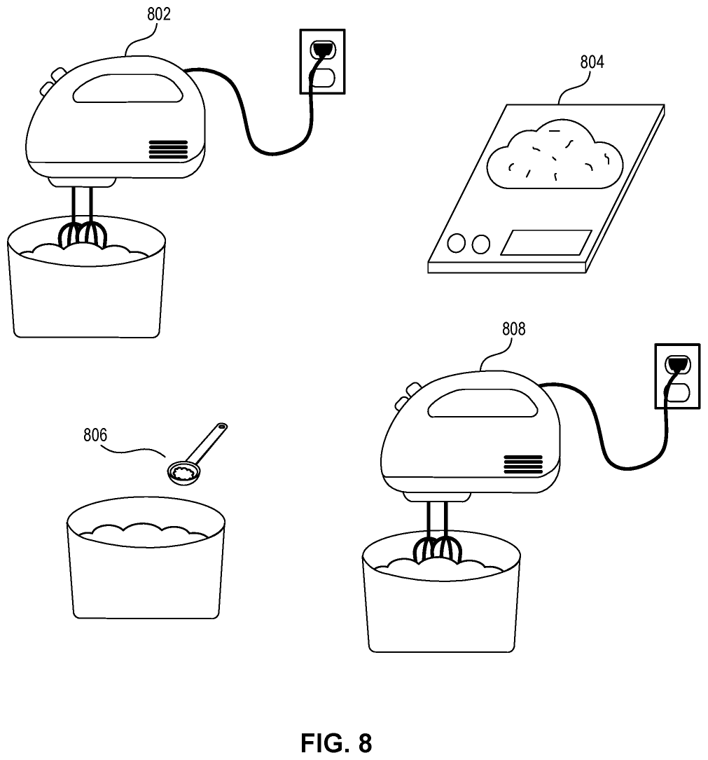

An embodiment can be understood with reference to FIG. 8, a schematic diagram showing how to make the base cookie batter or dough. For exemplary purposes only and not to be limiting, the cookie dough ingredients of Table A of FIG. 1 are used with the elements of FIG. 7. Butter 702 is mixed or blended such as in a large bowl. For example, an electric mixer 802 can mix, blend, or fluff butter 702. Or, butter 702 can be mixed and smoothed to a creamy texture manually (not shown). Further, an egg 706 is added and mixed well into the creamy butter. Further, the flour 704 is added and then the water 708. The totality of ingredients is then mixed with electric mixer or manually. The amount of water may be adjusted if need to for example if the dough remains too dry or flakey and doesn't cling together as one ball of dough.

The mixed cookie dough in 802 is removed from the large bowl then placed on a scale 804 to weigh. Subsequently, the dough is placed back into the bowl as shown in 806. Also shown in 806 is the cannabis butter, which was stored in resistant glass container 604 in the refrigerator, being added to the mixed, base cookie dough. In an embodiment, 5 to 7% of the cannabis butter (e.g., of FIG. 6) is added against the weight of the batter for animals with medical diagnostic. In another embodiment, 2 to 3% of the cannabis butter (e.g., of FIG. 6) is added against the weight of the batter for animals with no medical diagnostic. The new mixture of base cookie dough with cannabis butter is mixed well 808 and then placed on a cutting board with some flour sprinkled on top of the cutting board so that the batter will not stick on the surface. The batter is then kneaded for about 30 seconds. More flour can be sprinkled onto the batter as needed, for example if the batter begins to stick to the kneading instrument, be it a person's hands or any other type of kneading mechanism.

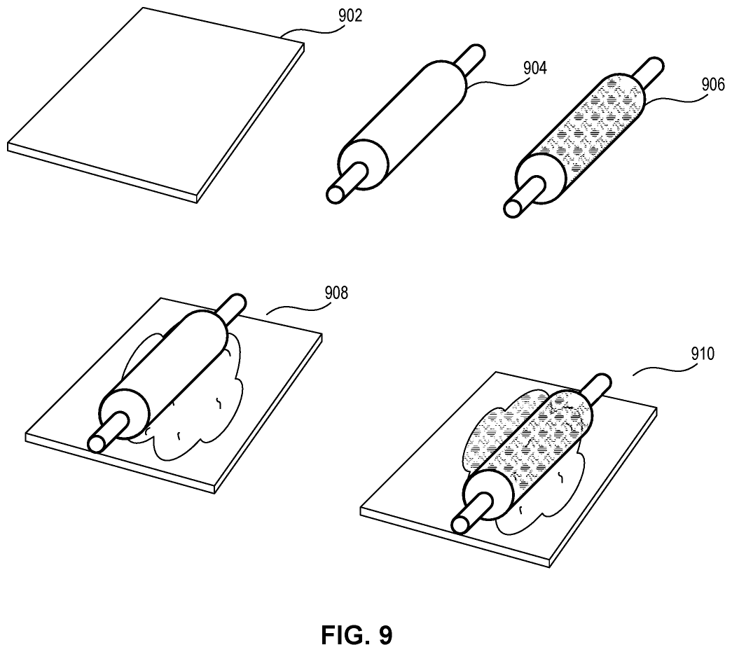

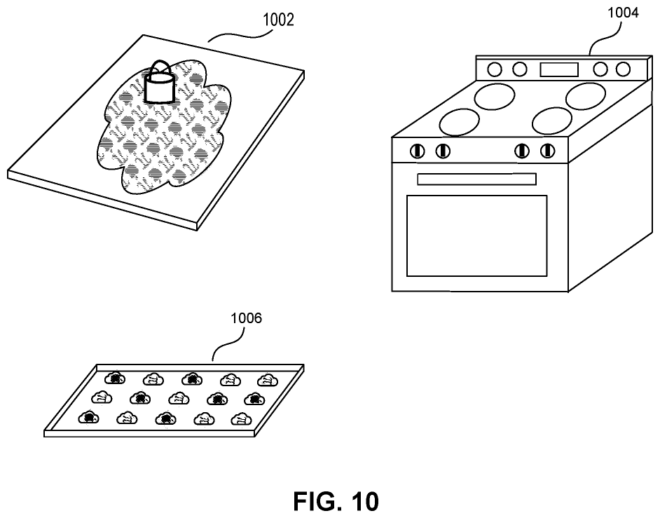

In an embodiment, FIGS. 9-10 describe the final steps for the innovative snack making. An embodiment can be understood with reference to FIG. 9, a schematic diagram of the equipment for achieving the rolled cookie dough embossed with the distinctive pattern. A typical rolling pin 904 is used to flatten the batter approximately to 7 mm thickness on a standard cutting or rolling board 902 and as shown in image 908. Then a specially engraved rolling pin 906 is used to imprint the distinguished design thereon onto the batter. Such specially engraved rolling pin 906 is rolled onto the cookie dough by pressing the pin 906 on the batter very slowly and with enough weight so as to imprint the pattern, but not to disturb or alter the thickness in a significant manner, as shown in image 910.

An embodiment can be understood with reference to FIG. 10, a schematic diagram of the process for cutting the cookies into smaller sizes and baking such cookies. The cookies are cut into smaller pieces 1002 such as by a cookie cutter on rolling board 902. It should be appreciated that the cookie dough can be cut by other mechanism such as but not limited to a knife, a spoon, with the finger, and so on. The cookies are placed on a cookie tray 1006 and placed in the oven 1004 to bake at 350 degrees Fahrenheit for approximately 10 to 15 minutes. When using the amounts as described in Table A or Table B of FIG. 1, the resulting cookie dough produces approximately 22-25 cookies.

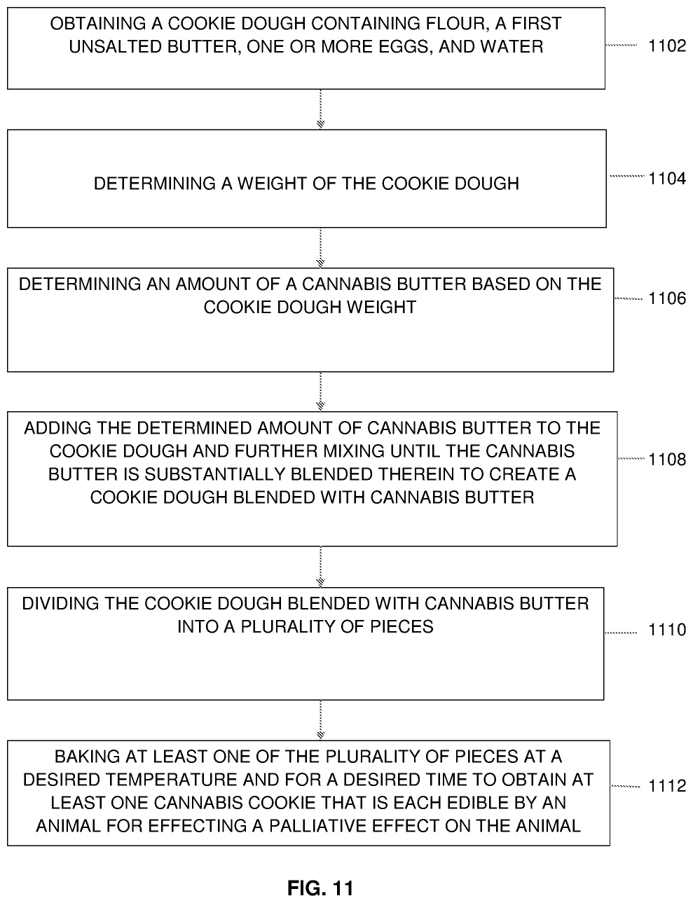

An embodiment can be understood with reference to FIG. 11, a flowchart showing an example of a method for making cannabis cookies. The method includes, at step 1102, obtaining a cookie dough containing flour, a first unsalted butter, one or more eggs, and water (e.g., 802 of FIG. 8). The method includes, at step 1104, determining a weight of the cookie dough (e.g., 804 of FIG. 8). The method includes, at step 1106, determining an amount of a cannabis butter based on the cookie dough weight. The method includes, at step 1108, adding the determined amount of cannabis butter to the cookie dough (e.g., 806 of FIG. 8) and further mixing until the cannabis butter is substantially blended therein to create a cookie dough blended with cannabis butter (e.g., 808 of FIG. 8). The method includes, at step 1110, dividing the cookie dough blended with cannabis butter into a plurality of pieces (e.g., 1102 of FIG. 10). The method includes, at step 1112, baking at least one of the plurality of pieces at a desired temperature and for a desired time to obtain at least one cannabis cookie that is each edible by an animal for effecting a palliative effect on the animal (e.g., 1106 and 1104 of FIG. 10).

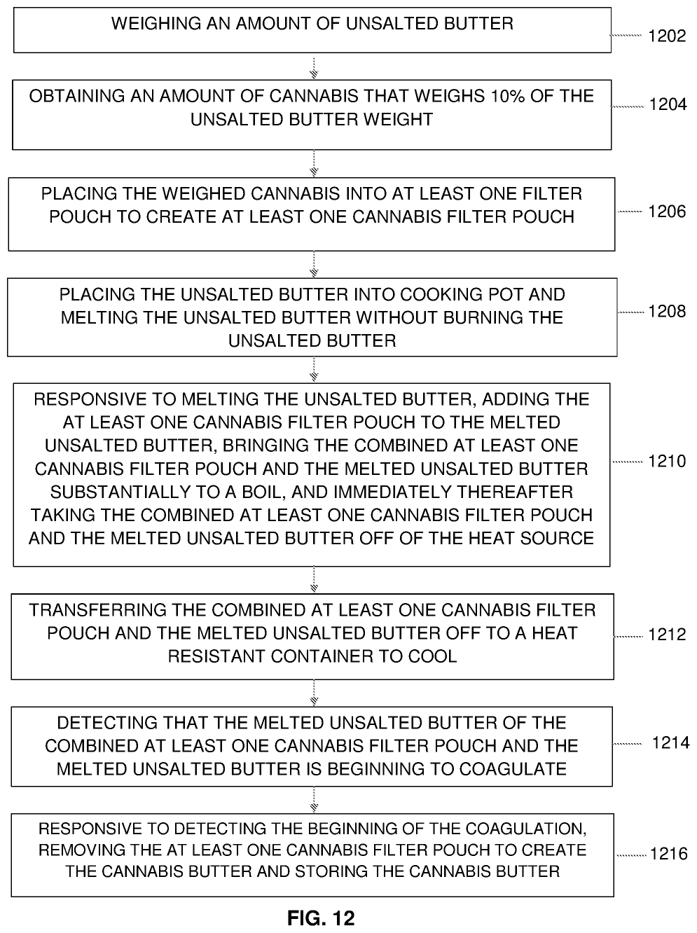

An embodiment can be understood with reference to FIG. 12, a flowchart showing an example of a method for making cannabis butter. The method includes, at step 1202, weighing an amount of unsalted butter (e.g., 202 or 210 of FIG. 2). The method includes, at step 1204, obtaining an amount of cannabis that weighs 10% of the unsalted butter weight (e.g., FIG. 3). The method includes, at step 1206, placing the weighed cannabis into at least one filter pouch to create at least one cannabis filter pouch (e.g., 206 of FIG. 2). The method includes, at step 1208, placing the unsalted butter into cooking pot and melting the unsalted butter without burning the unsalted butter (e.g., 502 of FIG. 5). The method includes, at step 1210, responsive to melting the unsalted butter, adding the at least one cannabis filter pouch to the melted unsalted butter (e.g., 602 of FIG. 6), bringing the combined at least one cannabis filter pouch and the melted unsalted butter substantially to a boil, and immediately thereafter taking the combined at least one cannabis filter pouch and the melted unsalted butter off of the heat source. The method includes, at step 1212, transferring the combined at least one cannabis filter pouch and the melted unsalted butter off to a heat resistant container to cool (e.g., 604 of FIG. 6). The method includes, at step 1214, detecting that the melted unsalted butter of the combined at least one cannabis filter pouch and the melted unsalted butter is beginning to coagulate. The method includes, at step 1216, responsive to detecting the beginning of the coagulation, removing (e.g., after approximately 8-10 hours from when the pouch was added to the butter) the at least one cannabis filter pouch to create the cannabis butter and storing the cannabis butter (e.g., 604 of FIG. 6 and the storing receptacle is not shown).

### Good Effects—Improvement

It has been found that after consuming the innovative cookie, a dog was able stand and walk again in the matter of overnight, whereas he could not do so before consuming the snack. Further, it has been found that while the animal's cognitive dysfunction and anxiety may be still present, such were much improved. In addition, it has been found that the product is very easy to consume instead of trying to force a pill down the throat of animal or trick the animal with food to have him take the pill and possibly resulting in the animal spitting out the medicine.

### Other Exemplary Embodiments

In an embodiment, cannabidiol (CBD) oil with THC is used to make the cannabis cookie dough, instead of using the cannabis butter. In an embodiment, one could use 100% CBD oil if THC affects the animal's condition. In an embodiment, other products using the innovative cannabis cookies are contemplated such as adding the crushed cookies or cannabis butter to horse bedding. Such cookies in broken form can be used to make dog or cat food, can be used to make an additive for wet pet food, can be freeze dried or dried by any manner to make the cannabis butter in dry form. Further, the dried butter can be used to sprinkle on animal feed or meat that they eat (e.g., for wild animals).

Thus, by these and other embodiments, the innovative cannabis butter and/or cannabis cookies can help make sick animals or animals with behavioral issues or terminally ill animals feel comfortable, giving them better quality of life and also with hopes to reduce unnecessary euthanasia.

More specifically, in an embodiment, when using CBD oil instead of cannabis butter, the amounts are described herein below. It should be appreciated that CBD oil is extracted from hemp, not from marijuana, and therefore, is a different product from the innovative product (butter). Most of the CBD oil contains multi-chain triglyceride (MCT) oil that is an amazing oil that is usually contained in coconut oil. An embodiment can include CBD oil with or without THC. If the CBD oil has THC, the amount used should be no more than 0.3% of the CBD oil. At present, 0.3% is the legal limit for amount of THC that can be contained in CBD oil in the US market, whatever the strength. This is same for human CBD oil as well.

More specifically, the amount of CBD oil an embodiment uses CBD oil, is as follows:

The amount is the same for small, medium, and large animals: give between 0.1 ml to 0.5 ml per kg of weight, twice a day.

This is for:

Small animals: Animal CBD oil that contains 100 mg of CBD in ⅛th tsp serving sizes which would have 4 mg whole hemp plant essential oil.

Medium size animals: Animal CBD oil that contains 500 mg of CBD in ⅛th tsp serving sizes which would have 4 mg whole hemp plant essential oil.

Large size animals: Animal CBD oil that contains 1000 mg of CBD in ⅛th tsp serving sizes which would have 4 mg whole hemp plant essential oil.

It should be appreciated that one skilled in the art can purchase from a particular manufacturer that sells animal CBD oil with or without THC. The amount of THC is limited as mentioned above (e.g., must be less than 0.3%).

In accordance with embodiments herein, it should be appreciated that the innovative cannabis butter can be added to wet food or as additive to any snack or pet food products during the cooking process. One can make a birthday cake for dogs and cats using the butter, regular dog food, snack, etc. Such innovative cannabis butter can be used in many edible products. However, such innovative butter is intended mainly for palliative care and not as something to give to healthy dogs or healthy cats on everyday basis.

In accordance with an embodiment, up to 0.5 ml of CBD oil to 6 table spoons of unsalted butter is used in the making of the cannabis cookie dough, instead of using the innovative cannabis butter. However, it has been found that the CBD oil may breakdown and lose its benefits when baked or cooked in heat. While the cookies with CBD oil may bake at 350 F, the CBD may break down and start losing its benefits when cooked over 400 F heat.

It should be appreciated that the stronger the CBD concentration, the stronger the treats will be.

In an embodiment, cannabigerol (CBG) oil is used in place of cannabis butter. CBG is the base matter that creates CBD, THC, and cannabichromene (CBC). As with CBD, CBG has many benefits. Many of the benefits overlap with CBD, however CBG does have different benefits as well, such as helping with bladder dysfunction and IBS (irritable bowel disease). It should be appreciated that “full spectrum” CBD contains some CBG.

In an embodiment, if CBG is used in the making of the innovative animal treats, the same dosage of CBG is used as with CBD oil, e.g., up to 0.5 ml in 6 table spoons of unsalted butter. Thus, embodiments herein can be the same as using CBD. Embodiments include either the cannabis butter or use regular unsalted butter plus CBG oil. CBG, could be more beneficial to use if the animal has intestinal inflammation issues or immune system issues.

In an embodiment, the cannabis butter can be made in many different strengths, depending on the types of marijuana strains used. Further, the cannabis butter can be created to make treats not only for illnesses but also for psychological or behavioral issues. It should be appreciated that one can find many different kinds of strains depending on one's needs. For example, depending on the animal's symptoms, one can use different strains of marijuana.

For example, certain medical grade marijuana purchases can be used to create the cannabis butter to make dog treats for a dog with severe arthritis pain, another dog suffering from pain due to cancer, and another dog suffering from behavioral issues. In this real-life example, all such dogs, who ate from the same batch, received great results.

In an embodiment, category 1 (5%) is for animals that have not been diagnosed with any illnesses by veterinarian but have symptoms. An example of such situation is if someone has a dog that seems to have arthritis but the owner has not yet taken the dog to veterinarian for formal diagnoses or any type of examination for the symptoms. Such owner wants to try the dog treats to see if they will help the dog. One purpose of this category is because not everyone can afford to take their pets to veterinarian. Not only are the bills expensive, but so can be the medications. Thus, this category can serve those individuals with a pet that has arthritis or symptoms of other illnesses rather than do nothing for their pets. This innovation allows such owners and pets to have a choice to at least try and see the innovative treats extend the pets' lives even for several months. Also, nowadays, more pet owners prefer natural holistic care, as some like it for humans. Thus, an embodiment requires using less (5% v. 10%) because the animal does not have formal diagnoses.

Category 2 (10%) is for animals that have been formally diagnosed with illnesses by veterinarian and (preferably) suggested to take a strong pain medication such as, but not limited to, tramadol or steroids medication such as prednisone that has significant effects on internal organs. In one example, a dog was given tramadol for his severe arthritis pain and for after surgery one time, which his veterinarian cautioned might affect his liver or pancreas. And prednisone eventually shut down this dog's kidney. In this situation, the innovative cannabis cookie was given to the dog to make him comfortable so that he could breathe, for his inflamed esophagus that bent his air pipe below it. Thus, category 2 is for those pets with formal diagnoses and/or in palliative care and so that the pet owners who want to go for holistic care for less side effects than strong prescription medications that may shorten pets' lives or to save mediation costs.

In an embodiment, the size of the treats can be varied, depending on the size of the pets.

In an embodiment, the amounts are based on a 75 lbs dog. In accordance with another embodiment, one can make the dough of the treats as-is for any size of the pets then change the size of the treats. For example, one can use a small cookie cutter, medium, or large, and so on. Another example is if a dog is a very large dog such as a Great Dane that weighs 120 lbs, one can use a large cookie cutter or use the medium size and then give the dog more than one cookie, if needed. Typically, the average amount suggested is 3-5 treats at a time, two to three times a day. It may be helpful for the user to start with a small amount (e.g., one or two treats) to see how it works. Because the innovative treat is a dog or other animal treats and not a prescription-level treat, it is suggested to start small and see how the pet reacts to it first.

Further, it has been found that the tea bag-type filter works very well to brew the marijuana in butter. Because marijuana is a type of herb, it brews just like brewing tea, even in butter.

In an embodiment, to obtain the marijuana, one can go to a dispensary and consult with a person there. For example, one can explain that they need a kind that works for extreme pain and anxiety. Then the person at the dispensary may ask follow-up questions, such as if one would like the kind that has strong sedative effects. One can ask questions of the consultant, depending on the symptoms of the pets. One can go to medical section instead of the recreational section and can obtain very high grade, and organic if needed. One can ask for cannabis that could be used for edibles and still work well. For example, when making treats for a dog, the cannabis may need to be the kind that contains very strong pain relief effects and also works on nausea. Thus, one can consult at the dispensary as well as check the label of the item to be purchased and ask what each herb or content does to one's body. Typically, people at dispensary are very knowledgeable and helpful.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A process for the production of animal cookies, comprising:
obtaining a cookie dough containing flour, a first unsalted butter, one or more eggs, and water;
determining a weight of the cookie dough;
determining an amount of a cannabis butter based on the cookie dough weight;
adding the determined amount of cannabis butter to the cookie dough and further mixing until the cannabis butter is substantially blended therein to create a cookie dough blended with cannabis butter;
dividing the cookie dough blended with cannabis butter into a plurality of pieces; and
baking at least one of the plurality of pieces at a desired temperature and for a desired time to obtain at least one cannabis cookie that is each edible by an animal for effecting a palliative effect on the animal.

2. The process of claim 1, further comprising a process for the production of the cannabis butter, comprising:
weighing an amount of a second unsalted butter;
obtaining an amount of cannabis that weighs 10% of the second unsalted butter weight;
placing the weighed cannabis into at least one filter pouch to create at least one cannabis filter pouch;
placing the second unsalted butter into cooking pot and melting the second unsalted butter without burning the second unsalted butter;
responsive to melting the second unsalted butter, adding the at least one cannabis filter pouch to the melted second unsalted butter, bringing the combined at least one cannabis filter pouch and the melted second unsalted butter substantially to a boil, and immediately thereafter taking the combined at least one cannabis filter pouch and the melted second unsalted butter off of the heat source;
transferring the combined at least one cannabis filter pouch and the melted second unsalted butter off to a heat resistant container to cool;
detecting that the melted second unsalted butter of the combined at least one cannabis filter pouch and the melted second unsalted butter is beginning to coagulate; and
responsive to detecting the beginning of the coagulation, removing the at least one cannabis filter pouch to create the cannabis butter and storing the cannabis butter.

3. The process of claim 2, wherein filter pouch is unbleached.

4. The process of claim 2, wherein the cannabis butter is stored in a refrigerator.

5. The process according to claim 1, wherein the cookie dough is obtained according to a process comprising:
mixing 6 tablespoons of the first unsalted butter to a soft consistency to obtain a soft mixed first unsalted butter;
adding one egg of the one or more eggs to the soft mixed first unsalted butter and further mixing until the egg is substantially blended into the soft mixed first unsalted butter to obtain a blended butter and egg mixture;
adding 1 cup of flour into the blended butter and egg mixture and further mixing until the flour is substantially blended therein;
adding ¼ cup of water into the butter, egg, and flour blended mixture and further mixing until the water is substantially blended therein.

6. The process according to claim 5, wherein the plurality of pieces includes 20-25 pieces.

7. The process according to claim 1, wherein the determined amount of cannabis butter is in the range of 5% to 7% against the weight of the determined weight of the cookie dough intended for an animal with a medical diagnosis.

8. The process according to claim 1, wherein the determined amount of cannabis butter is in the range of 2% to 3% against the weight of the determined weight of the cookie dough intended for an animal with no medical diagnosis.

9. The process according to claim 1, further comprising, after creating the cookie dough blended with cannabis butter but before dividing the cookie dough blended with cannabis butter into the plurality of pieces:
placing the cookie dough blended with cannabis butter on a flat surface with flour sprinkled thereon to prevent the cookie dough blended with cannabis butter from sticking;
kneading the cookie dough blended with cannabis butter for substantially 30 seconds; and
using a rolling pin, flattening the cookie dough blended with cannabis butter to substantially 7 mm thickness.

10. The process according to claim 9, wherein dividing the cookie dough blended with cannabis butter into a plurality of pieces is performed using a cookie cutter.

11. The process according to claim 9, further comprising, after flattening the cookie dough blended with cannabis butter to substantially 7 mm thickness, engraving a distinguished design on the flattened cookie dough to distinguish the resulting cannabis cookie.

12. The process according to claim 11, wherein the engraved distinguished design is achieved by using a specially engraved rolling pin.

13. The process according to claim 1, wherein the desired temperature is 350 degrees and the desired baking time is 10-15 minutes.

14. The process according to claim 1, wherein the cannabis cookie is of a crisp quality, so that the cannabis cookie is chewable by an aging animal.

15. The process according to claim 14, further comprising crushing the at least one cannabis cookie into smaller pieces and adding the crushed pieces to animal feed.

16. The process according to claim 1, wherein obtaining the cookie dough includes carob powder to enhance appeal to an animal.

17. A process for the production of the cannabis butter, comprising:
weighing an amount of unsalted butter;
obtaining an amount of cannabis that weighs 10% of the unsalted butter weight;
placing the weighed cannabis into at least one filter pouch to create at least one cannabis filter pouch;
placing the unsalted butter into cooking pot and melting the unsalted butter without burning the unsalted butter;
responsive to melting the unsalted butter, adding the at least one cannabis filter pouch to the melted unsalted butter, bringing the combined at least one cannabis filter pouch and the melted unsalted butter substantially to a boil, and immediately thereafter taking the combined at least one cannabis filter pouch and the melted unsalted butter off of the heat source;
transferring the combined at least one cannabis filter pouch and the melted unsalted butter off to a heat resistant container to cool;
detecting that the melted unsalted butter of the combined at least one cannabis filter pouch and the melted unsalted butter is beginning to coagulate; and
responsive to detecting the beginning of the coagulation, removing the at least one cannabis filter pouch to create the cannabis butter and storing the cannabis butter.

18. The process of claim 17, wherein filter pouch is unbleached.

19. The process of claim 17, wherein the cannabis butter is stored in a cold receptacle to be available for a future use.

20. A process for the production of animal cookies, comprising:
obtaining a cookie dough containing flour, a first unsalted butter, one or more eggs, and water;
determining a weight of the cookie dough;
determining an amount of CBD oil based on the cookie dough weight;
adding the determined amount of CBD oil to the cookie dough and further mixing until the CBD oil is substantially blended therein to create a cookie dough blended with CBD oil;
dividing the cookie dough blended with CBD oil into a plurality of pieces; and
baking at least one of the plurality of pieces at a desired temperature and for a desired time to obtain at least one CBD oil cookie that is each edible by an animal for effecting a palliative effect on the animal.
